(19) United States
(12) Patent Application Publication
(10) Pub. No.: US 2017/0275494 A1
(43) Pub. Date: Sep. 28, 2017

(54) METHOD FOR PRODUCING AND USING AQUEOUS POLYURETHANE DISPERSIONS AND USE OF SAME IN COATING AGENTS

(71) Applicant: BASF SE, Ludwigshafen (DE)

(72) Inventors: Ekkehard JAHNS, Weinheim (DE); Timo MANGEL, Oetigheim (DE); Christine ROESCH, Mainz (DE); Paola ROMANATO, Frick (CH); Joachim PAKUSCH, Speyer (DE)

(73) Assignee: BASF SE, Ludwigshafen (DE)

(21) Appl. No.: 15/500,179

(22) PCT Filed: Jul. 24, 2015
(86) PCT No.: PCT/EP2015/067051

§ 371 Date: Jan. 30, 2017

(30) Foreign Application Priority Data
Aug. 1, 2014 (EP) 14179532.8

(51) Int. Cl. C09D 175/08; C09D 7/12

(52) U.S. Cl. CPC C09D 175/08; C09D 7/1233; C08K 5/42

(57) ABSTRACT

The present invention relates to the use of aqueous hybrid dispersions, wherein (a) an aqueous polyurethane dispersion is prepared and (b) said polyurethane dispersion is used as raw material for the additional synthesis of a polyacrylate dispersion and the resulting hybrid dispersion is used as binder in filled coating materials, in particular, as binder for the flexible roof coating.

The present invention relates to the use of an aqueous polyurethane dispersion, wherein the polyurethane has a polyalkylene oxide content of at least 10 g/kg of polyurethane and a sulfonated raw material content of at least 25 mmol per kg of polyurethane, as binder in filled coating materials, in particular, as binder for flexible roof coatings.

Aqueous polyurethane dispersions are used as low-solvent or solvent-free coating materials for lacquering wood, as leather lacquers and as printing ink binders. These applications usually involve clear lacquers or pigmented coatings. The advantage of these coatings based on aqueous polyurethane dispersions is that the microphase morphology can be controlled by choosing the relative proportions of hard and hard and soft segments along the polymer chains in the polyurethane. The mechanical properties are particularly noteworthy: high abrasion resistance, very good hardness, more specifically toughness, good elastic properties, in particular very good low-temperature elasticity.

Currently, polyurethane dispersions are generally not employed in filled lacquers, but also, for example, in leather or wood coatings. Clear lacquers or merely pigmented coatings comprising very little or no filler are generally employed here. Attempting to employ these binders in water-based coatings or paints having a relatively high filler content leads to distinct instabilities in the liquid coatings.

The proportion of fillers/pigments may be described by the pigment volume concentration (PVC). The pigment volume concentration expresses the volume ratio of pigments/fillers to binder in the cured lacquer film. Calculating the pigment volume concentration comprises initially calculating the volumes of the individual pigments, fillers and binders from the amounts (masses) and densities thereof (A. Goldschmidt, H.-J. Streitberger; BASF Handbuch Lackiertechnik; 2002; Vincentz Verlag), then the obtained volumes of the pigments and fillers comprised in the formulation are then divided by the volumes of all solid raw materials.

For simplicity, the additives likewise present in the formula are typically not taken into account in the calculation. Solvent and water are in any case no longer present in the dried coating and are not taken into account when calculating the PVC.

The PVC is typically expressed in % and is between 0% (clear lacquer with no pigments nor fillers) and 100% (only theoretically possible since no binders).

Coating materials according to the invention have, for example, a PVC in the range of from 5 to 85, it being appreciated that the binders are also suitable for use in clear lacquer applications comprising only very small proportions of added pigments and/or fillers or none at all. It is particularly preferable for flexible roof coatings to employ coatings having a PVC of about 10 to 40.

Typical prior art polyurethane dispersions are generally not “filler compatible”. Modifications to the known aqueous polyurethane dispersions must therefore be carried out in order to improve filler compatibility, a basic requirement for typical paint and coating applications having a medium to high filler content.

U.S. Pat. No. 5,629,402 describes coatings comprising polyurethane dispersions, said coatings being extremely permeable to water vapor while showing only a low tendency toward swellability in water. The polyurethane dispersions comprise ionic groups and polyethylene glycols as raw materials in the PU main chain and a crosslinking agent. Applications described are water vapor-permeable coatings for flexible substrates, such as textiles, leather, paper and the like. However, the use of the polyurethane dispersions described therein as raw materials in coatings leads to systems having only limited stability toward fillers.

The use of aqueous dispersions comprising polyurethanes for coating substrates such as textiles or leather has long been known (EP-A 595149).

DE 101 61156 describes aqueous dispersions comprising a polyurethane, synthesized from
a) diisocyanates,
b) diols, of which
b1) from 10 to 100 mol %, based on the total amount of diols (b), have a molecular weight of from 500 to 5000 and
b2) from 0 to 90 mol %, based on the total amount of diols (b), have a molecular weight of from 60 to 500 g/mol,
c) monomers other than the monomers (a) and (b) having at least one isocyanate group or at least one group which is reactive toward isocyanate groups and which, moreover, carry at least one hydrophilic group or a potentially hydrophilic group, which gives rise to the dispersibility of the polyurethanes in water,
d) optionally further polyfunctional compounds distinct from monomers (a) to (c) and comprising reactive groups which are alkaline hydroxyl groups, primary or secondary amino groups or isocyanate groups and
e) optional monofunctional compounds distinct from monomers (a) to (d) and comprising a reactive group which is an alcoholic hydroxyl group, a primary or secondary amino group or an isocyanate group, obtainable by reacting the monomers a), b), c) and optionally d) and e) in the presence of a cesium salt.

Furthermore, DE 101 61156 describes a method for coating, bonding and impregnating articles composed of different materials with these dispersions, the articles coated, bonded and impregnated with these dispersions, and the use of the dispersions according to the invention as coating materials stable to hydrolysis.

DE 101 61156 does not describe any use of PU dispersions as binders in filled coating materials, particularly not as binders for flexible roof coatings.

The present invention has for its object the development of polyurethane dispersions having distinctly improved filler compatibility compared to polyurethane dispersions known from the prior art and having particularly good properties in relation to toughness and elasticity, even at temperatures below freezing. These PU dispersions should exhibit advantages over conventional acrylate dispersions particularly when used as binders for filled elastic paints and coatings for horizontal roof surfaces.

The object was achieved, surprisingly, by an aqueous polyurethane dispersion having a polyalkylene oxide content of at least 10 g/kg of polyurethane and a sulfonated raw material content of at least 25 mmol per kg of polyurethane.

Surprisingly, it was found that polyurethane dispersions comprising long-chain alkanol-based polyethylene oxides and sodium salts of 2-aminoethyl-2-aminoethanesulfonic acid are particularly filler compatible.

To prepare the filler compatible polyurethane dispersion in accordance with the invention, it may be necessary, in order to achieve good filler compatibility, for this PU dispersion to comprise more functional groups than is necessary or useful for a PU dispersion alone, in conventional use as textile or leather coating material. Although this accordingly greater amount of hydrophilic groups in the PU dispersion contributes to greater water absorption of films of the pure PU dispersion, such a particularly well stabilized PU dispersion need not necessarily exhibit excessive water absorption of a highly filled paint. On the contrary, these synthesis steps afforded prepared PU dispersions which in fact exhibited lower levels of water absorption or water sensitivity of the filled paints prepared therefrom than was to be expected.

The polyurethane dispersions according to the invention may be prepared by the following method, as described in DE 10161156, the disclosure content of which is fully incorporated here by reference:

Aqueous dispersions comprising a polyurethane synthesized from
a) diisocyanates,
b) diols, of which
b1) from 10 to 100 mol %, based on the total amount of diols (b), have a molecular weight of from 500 to 5000, and
b2) from 0 to 90 mol %, based on the total amount of diols (b), have a molecular weight of from 60 to 500 g/mol,
c) monomers other than the monomers (a) and (b) having at least one isocyanate group or at least one group which is reactive toward isocyanate groups and which, moreover, carry at least one hydrophilic group or a potentially hydrophilic group, which gives rise to the dispersibility of the polyurethanes in water,
d) optionally, further polyvalent compounds which differ from the monomers (a) to (c) which have reactive groups, which groups are alcoholic hydroxyl groups, primary or secondary amino groups or isocyanate groups, and
e) optional monofunctional compounds distinct from monomers (a) to (d) and comprising a reactive group which is an alcoholic hydroxyl group, a primary or secondary amino group or an isocyanate group, obtainable by reacting the monomers a), b), c) and optionally d) and e) in the presence of a catalyst, e.g. a tin salt, such as dibutyltin dilaurate (DE-A 199 59 6539) or tin-free catalysts, for example based on bismuth neodecanoate (e.g. Borchikat® 315 from OMG Borchers GmbH, Langenfeld, Germany).

The aqueous dispersions according to the invention comprise polyurethanes which in addition to other monomers are derived from diisocyanates a), preference being given to using such diisocyanates a) as are typically employed in polyurethane chemistry. Suitable monomers (a) include in particular diisocyanates of formula X (NCO)2 where X is an aliphatic hydrocarbon radical comprising from 4 to 12 carbon atoms, a cycloaliphatic or aromatic hydrocarbon radical comprising from 6 to 15 carbon atoms or an araliphatic hydrocarbon radical comprising from 7 to 15 carbon atoms. Examples of such diisocyanates include tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, cis/cis and cis/trans isomers and mixtures consisting of these compounds.

Such diisocyanates are commercially available. Mixtures of these isocyanates of particular importance are mixtures of the respective structural isomers of diisocyanatotoluene and diisocyanatodiphenylmethane, the mixture of 80 mol % of 2,4-diisocyanatotoluene and 20 mol % of 2,6-diisocyanatotoluene being particularly suitable.

Furthermore, the mixtures of aromatic isocyanates, such as 2,4-diisocyanatotoluene and/or 2,6-diisocyanatotoluene, with aliphatic or cycloaliphatic isocyanates,

such as hexamethylene diisocyanate or IPDI, are particularly advantageous, the preferred mixing ratio of the aliphatic isocyanate to the aromatic isocyanate being from 4:1 to 1:4. In addition to the abovementioned compounds, the synthesis of the polyurethanes may also employ isocyanates bearing further capped isocyanate groups, for example uretdione groups, in addition to the free isocyanate groups. With a view to achieving good film formation and elasticity, suitable diols (b) especially include relatively high molecular weight diols (b1) having a molecular weight of about 500 to 5000 g/mol, preferably about 1000 to 3000 g/mol. The diols (b1) are, in particular, polyester polyols, which are known from, for example, Ullmanns Encyklopädie der technischen Chemie (Ullmann's Encyclopedia of Industrial Chemistry), 4th edition, Volume 19, pp. 62 to 65. Preference is given to using polyester polyols obtained by reaction of dihydric alcohols with dibasic carboxylic acids. In the place of the free polycarboxylic acids, it is also possible to produce the polyester polyols using the corresponding polycarboxylic anhydrides or the corresponding polycarboxylic acid esters of lower alcohols or their mixtures.

As sulfonated polyester polyols it is also possible to employ, for example, the compounds disclosed in EP 2 666 800, for example the product “SS55-225-130”, a sulfonated polyesterdiol comprising free sodium sulfonate groups, molecular weight 550; Crompton Corp., Middlebury Conn. The polycarboxylic acids may be aliphatic, cycloaliphatic, araliphatic, aromatic or heterocyclic and may optionally be substituted, for example by halogen atoms, and/or be unsaturated. Examples thereof which may be mentioned are: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids and dimethylsulfoisophthalic acid. Preference is given to dicarboxylic acids of the general formula HOOC—(CH2)y-COOH where y is a number from 1 to 20, preferably an even number from 2 to 20, for example succinic acid, adipic acid, sebacic acid and dodecanedicarboxylic acid. Suitable polyhydric alcohols include, for example, ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols and also diethylene glycol, triethylene glycol, tetraethylene glycol, polyethylene glycol, dipropylene glycol, polypropylene glycol, dibutylene glycol and polybutylene glycols. Preference is given to alcohols of general formula HO—(CH2)x-OH where x is a number from 1 to 20, preferably an even number from 2 to 20. Examples thereof include ethylene glycol, butane-1,4-diol, hexane-1,6-diol, octane-1,8-diol and dodecane-1,12-diol. Neopentyl glycol is also preferred.

Also suitable are polycarbonate diols, obtainable, for example, by reaction of phosgene with an excess of the low molecular weight alcohols cited as synthesis components for the polyester polyols. Also suitable are lactone-based polyester diols which are homo- or copolymers of lactones, preferably addition products of lactones having terminal hydroxyl groups onto suitable difunctional starter molecules. Suitable lactones are preferably lactones derived from compounds of general formula HO—(CH2)z-COOH where z is a number from 1 to 20 and one H atom of a methylene unit may also be substituted by a C1 to C4 alkyl radical. Examples include ε-caprolactone, β-propiolactone, γ-butyrolactone and/or methyl-ε-caprolactone and mixtures thereof. Suitable starter components are, for example, the low molecular weight dihydric alcohols cited hereinabove as a synthesis component for the polyester polyols. The corresponding polymers of ε-caprolactone are particularly preferred. Lower polyester diols or polyether diols may also be used as starters to prepare the lactone polymers. Instead of the polymers of lactones, it is also possible to use the corresponding chemically equivalent polycondensates of the hydroxycarboxylic acids corresponding to the lactones.

Suitable monomers (b1) further include polyether diols. Said polyether diols are in particular obtainable by polymerization of ethylene oxide, propylene oxide, butylene oxide, tetrahydrofuran, styrene oxide or epichlorohydrin with itself, for example in the presence of BF₃ or by addition of these compounds, optionally mixed or in succession, onto starting components having reactive hydrogen atoms, such as alcohols or amines, for example water, ethylene glycol, propane-1,2-diol, propane-1,3-diol, 1,2-bis(4-hydroxydiphenyl)propane or aniline. Particular preference is given to polytetrahydrofuran having a molecular weight of from 240 to 5000, especially from 500 to 4500. Mixtures of polyester diols and polyether diols may also be used as monomers (b1). Likewise suitable are polyhydroxyolefins, preferably those comprising 2 terminal hydroxyl groups, for example α,ω-dihydroxypolybutadiene, α,ω-dihydroxy polymethacrylic ester or α,ω-dihydroxy polyacrylic ester as monomers (c1). Such compounds are disclosed in EP-A 622 378 for example. Further suitable polyols are polyacetals, polysiloxanes and alkyd resins.

The polyols may also be employed as mixtures in a ratio of from 0.1:1 to 1:9.

The hardness and the modulus of elasticity of the polyurethanes can be increased when, besides the diols (b1), low-molecular-weight diols (b2) with a molecular weight of approximately 60 to 500, preferably of from 62 to 200 g/mol, are additionally employed as diols (b).

Monomers (b2) which are employed are, mainly, the structural components of the short-chain alkanediols which have been mentioned for the preparation of polyester polyols, with diols having 2 to 12 C atoms, unbranched diols having 2 to 12 C atoms and an even number of C atoms, and pentane-1,5-diol and neopentyl glycol being preferred.

Preferably, the amount of the diols (b1), based on the total amount of the diols (b), is from 10 to 100 mol % and the amount of the monomers (b2), based on the total amount of the diols (b), is from 0 to 90 mol %. The ratio of the diols (b1) to the monomers (b2) is particularly preferably 0.1:1 to 5:1, more preferably 0.2:1 to 2:1.

In order to ensure that the polyurethanes are water-dispersible, the polyurethanes are synthesized not only from components (a), (b) and optionally (d) but also from monomers (c) which are distinct from components (a), (b) and (d) and which bear at least one isocyanate group or at least one isocyanate-group reactive group and moreover bear at least one hydrophilic group or a group which can be converted into a hydrophilic group.

Hereinbelow, the term “hydrophilic groups or potentially hydrophillic groups” is abbreviated to “(potentially) hydrophilic groups”. The (potentially) hydrophilic groups react with isocyanates substantially more slowly than the functional groups of the monomers used to synthesize the polymer main chain.

The proportion of components comprising (potentially) hydrophilic groups in the total amount of components (a), (b), (c), (d) and (e) is generally measured such that the molar amount of the (potentially) hydrophilic groups based on the amount by weight of all monomers (a) to (e) is from 30 to 1000, preferably from 50 to 500 and more preferably from 80 to 300 mmol/kg.

The (potentially) hydrophilic groups may be nonionic or preferably (potentially) ionic hydrophilic groups. Suitable nonionic hydrophilic groups include in particular polyethylene glycol ethers composed of preferably from 5 to 150 and preferably from 40 to 120 ethylene oxide repeating units. The content of polyethylene oxide units is generally from 0.1 to 15 and preferably from 1 to 10 wt % based on the amount by weight of all monomers (a) to (e).

Preferred monomers comprising nonionic hydrophilic groups are polyethylene oxide diols, polyethylene oxide monools, and the reaction products of a polyethylene glycol and a diisocyanate which bear a terminally etherified polyethylene glycol radical. Such diisocyanates and processes for the preparation thereof are described in patent specifications U.S. Pat. No. 3,905,929 and U.S. Pat. No. 3,920,598.

Ionic hydrophilic groups are especially anionic groups such as sulfonate, carboxylate and phosphate groups in the form of the alkali metal or ammonium salts thereof and also cationic groups such as ammonium groups, in particular protonated tertiary amino or quaternary ammonium groups.

Potentially ionic hydrophilic groups are especially those which may be converted into the abovementioned ionic hydrophilic groups by simple neutralization, hydrolysis or quaternization reactions, i.e., carboxylic acid groups, or tertiary amino groups for example. (Potentially) ionic monomers (c) are described, for example, in Ullmanns Encyklopädie der technischen Chemie (Ullmann's Encyclopedia of Industrial Chemistry), 4th edition, Volume 19, pp. 311-313 and are described in detail, for example, in DE-A 14 95 745.

(Potentially) cationic monomers (c) of particular practical importance are especially monomers comprising tertiary amino groups, for example: tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, N-aminoalkyldialkylamines, the alkyl radicals and alkanediyl units of these tertiary amines consisting independently of from 1 to 6 carbon atoms. Also suitable are polyethers comprising tertiary nitrogen atoms and preferably two terminal hydroxyl groups, as obtainable in a conventional manner, for example, by alkoxylation of amines comprising two hydrogen atoms attached to amine nitrogen, for example methylamine, aniline or N,N′-dimethylhydrazine. Such polyethers generally have a molar weight of between 500 and 6000 g/mol.

These tertiary amines are converted into the ammonium salts, either with acids, preferably strong mineral acids such as phosphoric acid, sulfuric acid, hydrohalic acids, or strong organic acids or by conversion with suitable quaternization agents such as C1- to C6-alkyl halides or benzyl halides, for example bromides or chlorides.

Suitable monomers comprising (potentially) anionic groups typically include aliphatic, cycloaliphatic, araliphatic or aromatic carboxylic acids and sulfonic acids bearing at least one alcoholic hydroxyl group or at least one primary or secondary amino group. Preferred are dihydroxyalkylcarboxylic acids, especially those having 3 to 10 carbon atoms, as they are also described in U.S. Pat. No. 3,412,054. Particular preference is given to compounds of general formula (c1)

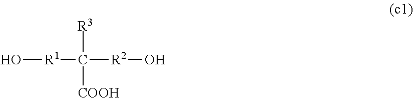

where R¹ and R² represent a C1 to C4 alkanediyl unit and R³ represents a C1 to C4 alkyl unit, dimethylolpropionic acid (DMPA) being especially preferred. Also suitable are corresponding dihydroxysulfonic acids and dihydroxyphosphonic acids such as 2,3-dihydroxypropanephosphonic acid.

Otherwise suitable are dihydroxyl compounds having a molecular weight from over 500 to 10 000 g/mol and comprising at least 2 carboxylate groups, which are disclosed in DE-A 39 11 827. They are obtainable by reacting dihydroxyl compounds with tetracarboxylic dianhydrides, such as pyromellitic dianhydride or cyclopentanetetracarboxylic dianhydride in the molar ratio 2:1 to 1.05:1 in a polyaddition reaction. Suitable dihydroxy compounds are in particular the monomers (b2) cited as chain extenders and diols (b1).

Suitable monomers (c) comprising isocyanate-reactive amino groups are aminocarboxylic acids such as lysine, β-alanine or the adducts, cited in DE-A 20 34 479, of aliphatic diprimary diamines onto α,β-unsaturated carboxylic or sulfonic acids.

Such compounds, for example, comply with the formula (c2)

H₂N—R⁴—NH—R⁵—X (c2)

where R⁴ and R⁵ are independently a C1 to C6 alkanediyl unit, preferably ethylene, and X is —COOH or —SO₃H.

Particularly preferred compounds of formula (c2) are N-(2-aminoethyl)-2-aminoethanecarboxylic acid and N-(2-aminoethyl)-2-aminoethanesulfonic acid and the corresponding alkali metal salts, sodium being particularly preferred as counterion. Also preferred are the adducts of the abovementioned aliphatic diprimary diamines onto 2-acrylamido-2-methylpropanesulfonic acid as are described in DE patent specification 19 54 090 for example. Further suitable aminosulfonic acids are, for example, sodium 2-((2-aminoethyl)amino)ethanesulfonate, diaminoalkylsulfonic acid and the salts thereof, for example ethylenediamino-β-ethylsulfonic acid, ethylenediaminopropylsulfonic or ethylenediaminobutylsulfonic acid, 1,2- or, 1,3-propylenediamino-β-ethylsulfonic acid. Provided that monomers comprising potentially ionic groups are employed, the conversion thereof into the ionic form may be effected before, during but preferably after the isocyanate polyaddition since the ionic monomers are often only sparingly soluble in the reaction mixture. The sulfonate or carboxylate groups are especially preferably present in the form of their salts with an alkali metal ion or with an ammonium ion as counterion.

The monomers (d) which are distinct from monomers (a) to (c) and which are optionally also constituents of the polyurethane generally serve to crosslink or to chain-extend. In general, they are more than dihydric/nonphenolic alcohols, amines having 2 or more primary and/or secondary amino groups and compounds which, besides one or more alcoholic hydroxyl groups, include one or more primary and/or secondary amino groups.

Alcohols having a hydricity greater than 2 and which may be used to establish a certain degree of branching or crosslinking are, for example, trimethylolpropane, glycerol and sugar. Also suitable are monoalcohols which, in addition to the hydroxyl group, bear a further isocyanate-reactive group such as monoalcohols comprising one or more primary and/or secondary amino groups, e.g. monoethanolamine. Polyamines with 2 or more primary and/or secondary amino groups are primarily used when the chain extension and/or crosslinking is to take place in the presence of water since amines generally react with isocyanates more rapidly than do alcohols or water.

This is often necessary when aqueous dispersions of crosslinked polyurethanes or polyurethanes of high molecular weight are desired. The procedure in such cases comprises preparing prepolymers comprising isocyanate groups, rapidly dispersing said prepolymers in water and subsequently chain-extending or crosslinking said prepolymers by adding compounds comprising a plurality of isocyanate-reactive amino groups.

Amines which are suitable for this purpose are, in general, polyfunctional amines in the molecular weight range of from 32 to 500 g/mol, preferably from 60 to 300 g/mol, which comprise at least two amino groups selected from the group of the primary and secondary amino groups. Examples thereof include diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane. The amines may also be employed in blocked form, for example in the form of the corresponding ketimines (see, for example, CA-A 1 129 128), ketazines (cf., for example, U.S. Pat. No. 4,269,748) or amine salts (see U.S. Pat. No. 4,292,226). Oxazolidines are used, for example, in U.S. Pat. No. 4,192,937, too, as capped polyamines which can be employed for synthesizing the polyurethanes according to the invention for extending the chains of the prepolymers. Use of such capped polyamines generally comprises mixing said polyamines with the prepolymers in the absence of water and subsequently mixing this mixture with the dispersing water or a portion of the dispersing water, thus releasing the corresponding polyamines hydrolytically. It is preferred to use mixtures of di- and triamines; it is especially preferred to use mixtures of isophorone diamine (IPDA) and diethylene triamine (DETA).

The polyurethanes preferably comprise from 1 to 30 and more preferably from 4 to 25 mol %, based on the total amount of components (b) and (d), of a polyamine comprising at least 2 isocyanate-reactive amino groups as monomers (d). Alcohols having a hydricity greater than 2 and which may be used to establish a certain degree of branching or crosslinking are, for example, trimethylolpropane, glycerol and sugar. Monomers (d) higher than difunctional isocyanates may also be used for the same purpose. Commercially available compounds are, for example, the isocyanurate or the biuret of hexamethylene diisocyanate.

Monomers (e) which are optionally co-used are monoisocyanates, monoalcohols and monoprimary and -secondary amines. The proportion thereof is generally no more than 10 mol % based on the total molar amount of the monomers. These monofunctional compounds typically bear further functional groups such as olefinic groups or carbonyl groups and serve to introduce functional groups into the polyurethane which render possible the dispersal or crosslinking or further polymer-analogous reaction of the polyurethane. Suitable for this purpose are monomers such as isopropenyl-α,α-dimethylbenzyl isocyanate (TMI) and esters of acrylic or methacrylic acid such as hydroxyethyl acrylate, hydroxyethyl methacrylate, hydroxypropyl acrylate and hydroxypropyl methacrylate.

Coatings having a particularly good profile of properties are obtained especially when the monomers (a) employed are substantially only aliphatic diisocyanates, cycloaliphatic diisocyanates or TMXDI and the monomers (b1) employed are substantially only polyester diols synthesized from the cited aliphatic diols and diacids. This combination of monomers is superbly complemented, as component (c), by diaminosulfonic acid salts; very particularly by N-(2-aminoethyl)2-aminoethanesulfonic acid, N-(2-aminoethyl)-2-aminoethanecarboxylic acid or the corresponding alkali metal salts thereof, of which the sodium salts are most suitable, and a mixture of DETA/IPDA as component (d). The way in which the molecular weight of the polyurethanes may be adjusted through choice of the proportions of the mutually reactive monomers and of the arithmetic mean of the number of reactive functional groups per molecule is common general knowledge in the field of polyurethane chemistry.

Normally, components (a) to (e) and also their respective molar quantities are chosen such that the ratio A:B where A) is the molar amount of isocyanate groups and B) is the sum total of the molar amount of hydroxyl groups and the molar amount of functional groups capable of reacting with isocyanates in an addition reaction is from 0.5:1 to 2:1, preferably 0.8:1 to 1.5:1, particularly preferably 0.9:1 to 1.2:1. It is very particularly preferable when the ratio A:B is very close to 1:1.

The monomers (a) to (e) employed bear on average typically from 1.5 to 2.5, preferably from 1.9 to 2.1 and more preferably 2.0 isocyanate groups or functional groups capable of reacting with isocyanates in an addition reaction. The polyaddition of components (a) to (e) to prepare the polyurethane present in the aqueous dispersions according to the invention may be effected at reaction temperatures of from 20° C. to 180° C., preferably from 70° C. to 150° C., at atmospheric pressure or at autogenous pressure.

The reaction times required are typically in the range of from 1 to 20 hours, particularly in the range of from 1.5 to 10 hours. In the field of polyurethane chemistry it is known how the reaction time is affected by a multitude of parameters such as temperature, concentration of the monomers, reactivity of the monomers. The polyaddition of monomers a), b), c) and optionally d) and e) to prepare the PU dispersion according to the invention is effected in the presence of a catalyst.

In the field of polyurethane chemistry it is known how the reaction time is affected by a multitude of parameters such as temperature, concentration of the monomers, reactivity of the monomers.

Typical catalysts may be used to increase the rate of reaction of the diisocyanates. Catalysts suitable for this purpose include in principle all catalysts typically employed in polyurethane chemistry. These are, for example, organic amines, particularly tertiary aliphatic, cycloaliphatic or aromatic amines and/or Lewis-acidic organic metal compounds. Suitable Lewis-acidic organic metal compounds include, for example, tin compounds, such as, for example, tin(II) salts of organic carboxylic acids, for example tin(II) acetate, tin(II) octoate, tin(II) ethylhexanoate and tin(II) laurate and the dialkyltin(IV) salts of organic carboxylic acids, e.g. dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate. Metal complexes, such as acetylacetonates of iron, titanium, aluminum, zirconium, manganese, nickel and cobalt are also possible. Further metal catalysts are described by Blank et al. in Progress in Organic Coatings, 1999, vol. 35, pages 19-29.

Preferred Lewis-acidic organic metal compounds are dimethyltin diacetate, dibutyltin dibutyrate, dibutyltin bis(2-ethylhexanoate), dibutyltin dilaurate, dioctyltin dilaurate, zirconium acetylacetonate and zirconium 2,2,6,6-tetramethyl-3,5-heptanedionate.

Bismuth and cobalt catalysts and cesium salts may also be employed as catalysts.

Suitable cesium salts in this case are those compounds in which the following anions are used: F—, Cl—, ClO—, Cl03-, Cl04-, Br—, J-, JO3-, CN—, OCN—, NO2-, NO3-, HCO3-, CO3²⁻, S2-, SH—, HSO3-, S03²⁻, HSO4-, SO4²⁻, S2O2²⁻, S2O4²⁻, S2Os2-, S2O5²⁻, S2O12⁻, S2Oa2-, H2PO2-, H2PO4-, HPO4²⁻, PO4³⁻, P2O14-, (OCnH2n+1)-, (CnH2n-102)-, (CnH2n-302)- and (Cn+1H2n-204)2-, where n is a number from 1 to 20.

Of these, preference is given to cesium carboxylates in which the anion conforms to the formulae (CnH2n-102)- and (Cn+1H2n-204)2-, where n is from 1 to 20. Particularly preferred cesium salts comprise monocarboxylates of general formula (CnH2n-102)- as anions where n is from 1 to 20. In this connection, formate, acetate, propionate, hexanoate and 2-ethylhexanoate in particular are to be mentioned. Suitable polymerization apparatuses are stirred-tank reactors, particularly when, through co-use of solvents, a low viscosity and good heat transfer is ensured. When the reaction is carried out without solvent, the generally high viscosities and the generally only short reaction times mean that extruders, in particular self-cleaning multiscrew extruders, are particularly suitable.

The process known as the “prepolymer blending process” comprises initially preparing a prepolymer bearing isocyanate groups. Here, the components (a) to (d) are chosen such that the defined ratio A:B is greater than from 1.0 to 3, preferably from 1.05 to 1.5. The prepolymer is first dispersed in water and simultaneously and/or subsequently crosslinked by reaction of the isocyanate groups with amines bearing more than 2 isocyanate-reactive amino groups or chain-extended with amines bearing 2 isocyanate-reactive amino groups. Chain extension also occurs when no amine is added. In this case, isocyanate groups are hydrolyzed to give amine groups which react with any remaining isocyanate groups of the prepolymers to effect chain extension. The mean particle size (z-average), measured by dynamic light scattering using the Malvern® Autosizer 2 C, of the polyurethane dispersions thus prepared does not constitute an essential feature of the invention and is generally <1000 nm, preferably <500 nm, 40<nm, more preferably <200 nm and most preferably between 20 and less than 200 nm.

The polyurethane dispersions generally have a solids content of from 10 to 75 wt %, preferably from 20 to 65 wt %, and a viscosity of from 10 to 500 mPas (ICI cone and plate viscometer with measuring head C in accordance with ASTM D4287) measured at a temperature of 20° C. and a shear rate of 250 s-1).

Preferred solvents are infinitely miscible with water, have a boiling point of from 40° C. to 100° C. at atmospheric pressure and react only slowly with the monomers, if at all.

The dispersions are generally prepared by one of the following processes: in the “acetone process”, an ionic polyurethane is prepared from components (a) to (c) in a water-miscible solvent which boils at below 100° C. at atmospheric pressure. Sufficient water is then added to form a dispersion in which water represents the coherent phase. The “prepolymer mixing process” differs from the acetone process in that a prepolymer which bears isocyanate groups is initially prepared instead of a fully reacted (potentially) ionic polyurethane. Here, the components are chosen such that the defined ratio A:B is greater than from 1.0 to 3, preferably from 1.05 to 1.5. The prepolymer is first dispersed in water and subsequently optionally crosslinked by reaction of the isocyanate groups with amines bearing more than 2 isocyanate-reactive amino groups or chain extended with amines bearing 2 isocyanate-reactive amino groups. Chain extension also occurs when no amine is added. In this case, isocyanate groups are hydrolyzed to amine groups which react with any remaining isocyanate groups of the prepolymers to effect chain extension. If, in the preparation of the polyurethane, a solvent has been included, the majority of the solvent is usually removed from the dispersion, for example by distillation at reduced pressure. The dispersions preferably have a solvent content of less than 10 wt % and are more preferably solvent-free. The dispersions generally have a solids content of from 10 to 75 wt %, preferably from 20 to 65 wt %, and a viscosity of from 10 to 500 mPas (measured at a temperature of 20° C. and a shear velocity of 250 s-1).

Aqueous acrylate dispersions have become standard binders for architectural paints and roof coatings, for example as repair paints. They provide stable, long-life, water and weather resistant decorative coatings, generally on inorganic building materials but also on wood, old coatings and substrates or metal surfaces. When flat roofs are first installed or when they are being repaired, rolls of pre-prepared materials, for example bituminized fibrous materials or nonwoven fabrics, such as EPDM rubber or thermoplastic elastomers for example, are employed to protect them. An alternative possibility is the use of two-component liquid polymer preparations, for example epoxy resins or polyurethanes, which may be applied by rolling or spraying. A feature of these materials is that they are highly elastic and highly aging resistant.

Horizontal roof surfaces may also be coated using dispersion-bound paints similar to the paints of exterior coatings. However, these coatings should likewise be particularly elastic in order that they do not fail prematurely in the event of substrate damage (cracks, etc.) and allow ingress of rainwater into the building. These paints also need to be particularly weather and UV resistant. Dispersion-bound paints for horizontal roof coating are thus subject to increased demands which may differ from typical dispersion binders. Dispersion binders for horizontal roof coating are not generally described separately in the patent literature and consideration of the prior art thus entails recourse to architectural paint binders.

Such prior art binders are described in EP 771 328 for example, for instance in Examples A, J and K.

DE 10 161 156 essentially describes a water-based polyurethane dispersion, which may also be used for filled, horizontal roof coatings.

With the polyurethane dispersions according to the invention, having a polyalkylene oxide content of at least 10 g/kg of polyurethane and a sulfonated raw material content of at least 25 mmol per kg, it is possible to prepare coatings with high breaking strength and elongation at break.

For ecological reasons, filming of the polyurethane binder in the range of from 0° C. to 40° C. is sought, so that only small amounts, if any, of a film-forming assistant are required. In accordance with the invention, therefore, preference is given to polyurethane binders having a minimum film-forming temperature of from <0° C. to +40° C. Particular preference is given to polyurethane binders having a minimum film-forming temperature of from <0° C. to 20° C.

The aqueous polyurethane dispersions obtainable by the method according to the invention comprise polymer particles having a weight average particle diameter D_{w} in the range of from ≧10 to ≦500 nm, preferably from ≧20 to ≦400 nm and more specifically from ≧30 nm to ≦300 nm. Determination of the weight average particle diameters is known to the person skilled in the art and is carried out, for example, by the analytical ultracentrifugation method. In this specification, weight average particle diameter is understood to mean the weight average D_{w50} value determined by the method of analytical ultracentrifugation (cf. for this purpose S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175).

The aqueous polyurethane dispersions obtainable according to the invention having weight average particle diameters D_{w} of ≦400 nm exhibit surprisingly good flexibility even at low temperatures and are thus particularly suitable as binders for flexible roof coatings and other coating applications.

The corresponding polymer powders are moreover easily obtainable from the aqueous polymer dispersions according to the invention (e.g. by freeze- or spray-drying). These polymer powders obtainable according to the invention may also be used as components in the preparation of coating materials for flexible roof coatings and other coating applications including modification of mineral binders.

The aqueous polyurethane dispersion has a typical solids content of from 20 to 70 wt %, preferably from 35 to 60 wt %.

The aqueous polyurethane dispersion obtained may be used as such or mixed with further, generally film-forming, polymers as a binder composition in aqueous coating materials.

It will be appreciated that the aqueous polyurethane dispersions according to the invention obtainable by the method according to the invention may also be employed as a component in the preparation of adhesives, sealants, polymeric renders, papercoating slips, fiber webs and coating materials for organic substrates and also for modifying mineral binders.

The invention further provides a coating material in the form of an aqueous composition comprising
at least one polyurethane dispersion according to the invention, as defined above,
optionally at least one (in)organic filler and/or at least one (in)organic pigment,
optionally at least one customary assistant and
water.

The binder compositions according to the invention are preferably employed in aqueous paints, particularly in flexible roof coatings and architectural paints.

Fillers may be employed to enhance hiding power and/or to economize on white pigments. Blends of fillers and color pigments are preferably used to control the hiding power of the hue and the depth of shade.

Suitable pigments are, for example, inorganic white pigments such as titanium dioxide, preferably in the form of rutile, barium sulfate, zinc oxide, zinc sulfide, basic lead carbonate, antimony trioxide, lithopone (zinc sulfide+barium sulfate) or colored pigments, for example iron oxides, carbon black, graphite, zinc yellow, zinc green, ultramarine, manganese black, antimony black, manganese violet, Prussian blue or Paris green. In addition to the inorganic pigments, the dispersion paints according to the invention may also comprise organic color pigments, for example sepia, gamboge, Cassel brown, toluidine red, parared, Hansa yellow, indigo, azo dyes, anthraquinonoid and indigoid dyes and also dioxazine, quinacridone, phthalocyanine, isoindolinone and metal-complex pigments. Also suitable are synthetic white pigments with air inclusions to enhance light scattering, such as the Ropaque® and AQACelI® dispersions. Additionally suitable are the Luconyl® brands from BASF SE, for example Luconyl® yellow, Luconyl® brown and Luconyl® red, particularly the transparent versions.

Suitable fillers are, for example, aluminosilicates, such as feldspars, silicates, such as kaolin, talc, mica, magnesite, tobermorite, xonolite, alkaline earth metal carbonates, such as calcium carbonate, for example in the form of calcite or chalk, magnesium carbonate, dolomite, alkaline earth metal sulfates, such as calcium sulfate, silicon dioxide etc. The preference in flexible roof coatings and in paints is naturally for finely divided fillers. The fillers may be employed as individual components. In practice however, filler mixtures have proven particularly advantageous, for example calcium carbonate/kaolin, calcium carbonate/talc. Glossy coatings generally comprise only small amounts of very finely divided fillers or comprise no fillers.

Finely divided fillers may also be employed to enhance hiding power and/or to economize on white pigments. Blends of fillers and color pigments are preferably used to control the hiding power of the hue and the depth of shade.

The binders according to the invention achieve a particularly high breaking strength without particular disadvantages in terms of elongation at break when particularly finely divided fillers are employed, for example calcium carbonate having a mean particle size of <2 μm. Such products are often also available in already predispersed form as a slurry in water and this makes it possible to prepare paint particularly easily. Suitable calcium carbonate slurries are obtainable, for example, from Omya, Oftringen, Switzerland under the trade name Hydrocarb, for example Hydrocarb 95 having a mean particle size of 0.7 μm.

The proportion of pigments may be described by the pigment volume concentration (PVC). Elastic roof coating materials according to the invention have, for example, a PVC in the range of from 10 to 40, it being appreciated that the binders are also suitable for use in clear lacquer applications comprising only very small proportions of added pigments and/or fillers or none at all. The elasticity (elongation at break) generally increases with increasing quantities of binder in the coating.

The coating material according to the invention for the flexible roof coating and aqueous paints may comprise further assistants in addition to the polymer dispersion.

Typical assistants include, in addition to the emulsifiers employed in the polymerization, wetting agents or dispersants, such as sodium, potassium or ammonium polyphosphates, allkali metal and ammonium salts of acrylic or maleic anhydride copolymers, polyphosphonates, such as sodium 1-hydroxyethan-1,1-diphosphonate and the salts of naphthalenesulfonic acids, in particular the sodium salts thereof.

Further suitable assistants are flow control agents, defoamers, biocides and thickeners. Suitable thickeners are, for example, associative thickeners, such as polyurethane thickeners. The amount of thickener is preferably less than 1 wt %, particularly preferably less than 0.6 wt % thickener, based on the solids content of the paint.

Further suitable assistants are film-forming assistants and coalescence aids. Preference is given to using, for example, mineral spirits, ethylene glycol, propylene glycol, glycerine, ethanol, methanol, water-miscible glycol ethers and acetates thereof such as diethylene glycol, 1-methoxy-2-propanol, 2-amino-2-methyl-1-propanol, isooctanol, butyl glycol, butyl diglycol, diethylene glycol monobutyl ether, dipropylene glycol monomethyl or monobutyl ether, dipropylene glycol methyl ether, dipropylene glycol propyl ether, dipropylene glycol n-butyl ether, tripropylene glycol n-butyl ether, propylene glycol phenyl ether, butyl glycol acetate, butyl diglycol acetate, 2,2,4-trimethyl-1,3-pentanediol monoisobutyrate, diisobutyl esters of long-chain dicarboxylic acids such as Lusolvan® FBH or tripropylene glycol monoisobutyrate.

The paints according to the invention are prepared in known fashion by blending the components in customary mixers. A procedure which has proven particularly advantageous comprises preparing an aqueous paste or dispersion from the pigments, water and optionally the auxiliaries and only subsequently mixing the polymeric binder, i.e., generally the aqueous dispersion of the polymer, with the pigment paste or pigment dispersion respectively.

The paints according to the invention generally comprise from 30 to 75 wt % and preferably from 40 to 65 wt % of non-volatile constituents. Non-volatile constituents is to be understood as meaning all constituents excluding water, but at least the total amount of binder, pigment and assistant based on the solids content of the paint. The volatile constituents are predominantly water.

The paint according to the invention may be applied to substrates in customary fashion, for example by brushing, spraying, dipping, rolling, knifecoating etc.

It is preferably used as a flexible roof coating medium, i.e., for coating flat or inclined parts of buildings. These parts of buildings may be mineral substrates such as renders, plaster or plasterboard, masonry or concrete, wood, wood-based materials, metal or polymer, e.g. PVC, thermoplastic polyurethane, EPDM, epoxy resin, polyurethane resin, acrylate resin or bituminous material as coating or continuous sheet material.

The paints according to the invention are notable for their ease of handling, good processing properties and improved elasticity. The paints have a low noxiant content. They have good performance characteristics, for example good fastness to water, good adherence in the wet state, good block resistance, good recoatability and good weathering resistance and they exhibit good flow on application. The equipment used is easily cleaned with water.

The invention is more particularly described with reference to the nonlimiting examples which follow.

### EXAMPLE 1

456.05 g of a polyesterdiol of adipic acid, neopentyl glycol and 1,6-hexanediol having an OH number of 56,
39.69 g of a butanol-based polyethylene oxide having an OH number of 15 and
0.1932 g of dibutyltin dilaurate were initially charged in a stirred flask and heated to 60° C. To this were added dropwise 132.05 g of 4,4′-diisocyanatodicyclohexylmethane and 67.69 g (0.3185 mol) of isophorone diisocyanate over 5 minutes. The resulting mixture was diluted with 117.20 g of acetone and stirred for 1 hour at 74° C. Subsequently, 20.30 g of 1,4-butanediol were added rapidly and the mixture was further stirred at 74° C. After 2 hours, the mixture was diluted with 500.98 g of acetone and cooled down to 50° C. The NCO content was determined as 1.01 wt % (calculated: 1.00 wt %).

30.81 g of a 50% aqueous solution of the sodium salt of 2-aminoethyl-2-aminoethanesulfonic acid are added over 5 minutes at 50° C. and the mixture is further stirred for an additional 5 minutes. The mixture is then diluted with 743.47 g of water over 24 minutes at 50° C. and then chain-extended with 4.21 g of diethylenetriamine and 2.06 g of isophoronediamine in 36.92 g of water.

After distillation of the acetone, a finely divided dispersion having a solids content of about 45%, a particle size of 91.7 nm and a pH of 9.46 was comprised.

### COMPARATIVE EXAMPLE 1

456.05 g of a polyesterdiol of adipic acid, neopentyl glycol and 1,6-hexanediol having an OH number of 56,
39.69 g of a butanol-based polyethylene oxide having an OH number of 15 and
0.1932 g of dibutyltin dilaurate were initially charged in a stirred flask and heated to 60° C. To this were added dropwise 132.05 g of 4,4′-diisocyanatodicyclohexylmethane and 67.69 g (0.3185 mol) of isophorone diisocyanate over 5 minutes. The resulting mixture was diluted with 117.20 g of acetone and stirred for 1 hour at 74° C. Subsequently, 20.30 g of 1,4-butanediol were added rapidly and the mixture was further stirred at 74° C. After 2 hours, the mixture was diluted with 500.98 g of acetone and cooled down to 50° C. The NCO content was determined as 1.01 wt % (calculated: 1.00 wt %).

24.97 g of a 50% aqueous solution of the sodium salt of the Michael adduct of ethylene diamine to acrylic acid are added over 5 minutes at 50° C. and the mixture is further stirred for an additional 5 minutes. The mixture is then diluted with 743.47 g of water over 24 minutes at 50° C. and then chain-extended with 4.21 g of diethylenetriamine and 2.06 g of isophorone diamine in 36.92 g of water.

After distillation of the acetone, a finely divided dispersion having a solids content of about 45%, a particle size of 96.8 nm and a pH of 9.23 was comprised.

### EXAMPLE 2

352.2 g of a polyesterdiol of adipic acid, neopentyl glycol and 1,6-hexanediol having an OH number of 56,

42.85 g of a butanol-based polyethylene oxide having an OH number of 15 and 0.26 g of a tin-free catalyst based on bismuth neodecanoate, 75% strength in acetone (Borchikat 315, OMG Borchers), were initially charged in a stirred flask and heated to 56° C. To this were added dropwise 72.83 g of 4,4′-diisocyanatodicyclohexylmethane and 61.3 g (0.3185 mol) of isophorone diisocyanate over 5 minutes. The resulting mixture was then diluted with 96.32 g of acetone and stirred for 1 hour and 15 minutes at 76° C. Subsequently, 18.39 g of 1,4-butanediol were added rapidly and the mixture was further stirred at 74° C. After 2 hours, the mixture was diluted with 413.41 g of acetone and cooled down to 50° C. The NCO content was determined as 1.27 wt % (calculated: 1.31 wt %).

39.21 g of a 50% aqueous solution of the sodium salt of 2-aminoethyl-2-aminoethanesulfonic acid are added over 5 minutes at 50° C. and the mixture is further stirred for an additional 5 minutes. The mixture is then diluted with 664.15 g of water over 15 minutes at 50° C. and then chain-extended with 3.81 g of diethylenetriamine and 1.86 g of isophorone diamine in 36.92 g of water.

After distillation of the acetone, a finely divided dispersion having a solids content of about 40.8%, a particle size of 93 nm and a pH of 9.74 was comprised.

### EXAMPLE 3

81.94 g of 2-butyl-2-ethyl-1,3-propanediol, 39.69 g of a butanol-based polyethylene oxide having an OH number of 15, 258.76 g of PolyTHF 2000 and 0.4 g of tin-free catalyst based on bismuth neodecanoate, 75% strength in acetone (Borchikat 315, OMG Borchers), were initially charged in a stirred flask and heated to 56° C. To this were added dropwise 78.9 g of bis(4-isocyanotocyclohexyl)methane and 66.4 g of isophorone diisocyanate over 5 minutes. The resulting mixture was then diluted with 97 g of acetone and stirred for 2 hours and 35 minutes at 74° C. Subsequently, 19.9 g of 1,4-butanediol were added dropwise and the mixture was further stirred at 74° C. After 2 hours and 40 minutes, the mixture was diluted with 417 g of acetone and cooled down to 50° C. The NCO content was determined as 1.25 wt % (calculated: 1.18 wt %).

30.3 g of a 50% aqueous solution of the sodium salt of 2-aminoethyl-2-aminoethanesulfonic acid are added over 5 minutes at 50° C. and the mixture is further stirred for an additional 5 minutes. The mixture is then diluted with 660.6 g of water over 15 minutes at 50° C. and then chain-extended with 4.12 g of diethylenetriamine and 2.02 g of isophorone diamine in 36.21 g of water.

After distillation of the acetone, a finely divided dispersion having a solids content of about 44.5%, a particle size of 91.8 nm and a pH of 8.03 was comprised.

### EXAMPLE 4

162.38 g of 2-butyl-2-ethyl-1,3-propanediol, 52.55 g of a butanol-based polyethylene oxide having an OH number of 15, 146.51 g of PolyTHF 2000 and 0.39 g of tin-free catalyst based on bismuth neodecanoate, 75% strength in acetone (Borchikat 315, OMG Borchers), were initially charged in a stirred flask and heated to 56° C. To this were added dropwise 89.32 g of bis(4-isocyanotocyclohexyl)methane and 75.17 g of isophorone diisocyanate over 5 minutes. The resulting mixture was then diluted with 95.74 g of acetone and stirred for 3 hours and 15 minutes at 76° C. Subsequently, 22.55 g of 1,4-butanediol were added dropwise and the mixture was further stirred at 77° C. After 1 hour, the mixture was diluted with 415 g of acetone and cooled down to 50° C. The NCO content was determined as 1.3 wt % (calculated: 1.35 wt %).

34.35 g of a 50% aqueous solution of the sodium salt of 2-aminoethyl-2-aminoethanesulfonic acid are added over 5 minutes at 50° C. and the mixture is further stirred for an additional 5 minutes. The mixture is then diluted with 658.36 g of water over 15 minutes at 50° C. and then chain-extended with 4.67 g of diethylenetriamine and 2.28 g of isophorone diamine in 41 g of water.

After distillation of the acetone, a finely divided dispersion having a solids content of about 40.9%, a particle size of 85.8 nm and a pH of 9.78 was comprised.

### EXAMPLE 5

81.22 g of 2-butyl-2-ethyl-1,3-propanediol, 46 g of a butanol-based polyethylene oxide having an OH number of 15, 261.61 g of a polyesterpolyol based on hexanedioic acid and 2,2-dimethyl-1,3-propanediol and 1,6-hexanediol having an OH number of 56 and 0.27 g of tin-free catalyst based on bismuth neodecanoate, 75% strength in acetone (Borchikat 315, OMG Borchers), were initially charged in a stirred flask and heated to 57° C. To this were added dropwise 78.18 g of bis(4-isocyanotocyclohexyl)methane and 65.8 g of isophorone diisocyanate over 5 minutes. The resulting mixture was then diluted with 97 g of acetone and stirred for 3 hours and 30 minutes at 76° C. Subsequently, 19.74 g of 1,4-butanediol were added dropwise and the mixture was further stirred at 74° C. After 1 hour, the mixture was diluted with 417.4 g of acetone and cooled down to 50° C. The NCO content was determined as 1.15 wt % (calculated: 1.17 wt %).

30.07 g of a 50% aqueous solution of the sodium salt of 2-aminoethyl-2-aminoethanesulfonic acid are added over 5 minutes at 50° C. and the mixture is further stirred for an additional 5 minutes. The mixture is then diluted with 660.76 g of water over 17 minutes at 50° C. and then chain-extended with 4.09 g of diethylenetriamine and 2 g of isophorone diamine in 35.89 g of water.

After distillation of the acetone, a finely divided dispersion having a solids content of about 42.1%, a particle size of 102.8 nm and a pH of 9.87 was comprised.

### APPLICATIONS—RELATED TESTS

### a) Preparation of the Paint Formulations

The constituents shown in table 1 (amounts in g) were used to prepare in the order shown from top to bottom, with stirring using a disc stirrer at 400-2500 revolutions per minute, the roof membrane formulations based on the exemplary aqueous polymer dispersions.

TABLE 1

| | Roof membrane formulation | | | | | |
|---|---|---|---|---|---|---|
| | A | A1 | B | C | D | E |
| | Dispersion example | | | | | |
| | 1 | Comp. 1 | 2 | 3 | 4 | 5 |
| Dispersion amount [g] | 62 | 62 | 58 | 63.5 | 63 | 65 |
| Lutensol TO82 | 0.4 | 0.4 | 0.4 | 0.4 | 0.4 | 0.4 |
| Agitan 282 | 0.5 | 0.5 | 0.5 | 0.5 | 0.5 | 0.5 |
| Dispex CX 4320 | 1.2 | 1.2 | 1.2 | 1.2 | 1.2 | 1.2 |
| Omyacarb 5GU | 29 | 29 | 36.5 | 34 | 34 | 31.5 |
| Water | 6 | 6 | 3 | 0 | 0 | 0 |
| Rheovis PU 1270 | 0.5 | 0.5 | 0.2 | 0.4 | 0.4 | 0.4 |
| Agitan 282 | 0.4 | 0.4 | 0.4 | 0.4 | 0.4 | 0.4 |

### Raw Materials Used

### 1) Lutensol TO 82, BASF SE, Ludwigshafen

### 2) Agitan 282, Münzing Chemie GmbH, Heilbronn

### 3) Dispex CX 4320, BASF SE, Ludwigshafen

### 4) Hydrocarb 95 ME, Omya, Oftringen, Switzerland

### 5) Omyacarb 5 GU, Omya, Oftringen, Switzerland

### 6) Omyacarb Extra CL, Omya, Oftringen, Switzerland

### 7) Rheovis PU 1270, BASF SE, Ludwigshafen

Once the last component had been added the mixture was further stirred until all components are homogeneously mixed (about 10 min) and the roof membrane formulation obtained is subsequently transferred into a DAC 400 FVZ Speed Mixer from Hauschild for 0.5 min at 2000 rpm. The roof membrane formulation has a solids content of about 63-67%, a pigment volume concentration of about 29 and a viscosity of 8000-10000 mPas (Brookfield, spindle 6, 20 rpm).

### b) Preparation of the Coatings and Test Specimens

The abovementioned roof membrane formulation was applied to a teflon-coated substrate in a layer thickness of 1.2 mm with a knife coater. The coatings thus obtained were subsequently dried for 7 days in a conditioning chamber at 50% relative humidity and 23° C. The resulting dry layer thickness is about 0.60 mm. After removal of the coating from the substrate, the required test specimens were cut out with appropriate cutting dies.

### c.) Tensile Strength, Breaking Strength and Elongation at Break Testing

Dumbells of size S1 were cut out of the coatings described hereinabove using a cutting die. Testing was carried out according to DIN 53504. The dumbells are clamped in a tensile/elongation tester from Zwick and subsequently pulled apart at a rate of 200 mm/min until they break.

TABLE 2
Testing of the roof membrane formulation

| | Roof membrane formulation | | | | | | |
|---|---|---|---|---|---|---|---|
| | | | Comp. | | | | |
| | | A | 1 | B | C | D | E |
| Maximum force | N/mm² | 4.41 | 3.2 | 4.09 | 3.64 | 4.48 | 5.09 |
| Elongation at | % | 775 | 40 | 855 | 603 | 424 | 638 |
| maximum strength | | | | | | | |
| Breaking strength | N/mm² | 4.37 | 3.15 | 4.08 | 3.63 | 4.47 | 5.09 |
| Elongation at break | % | 785 | 42 | 856 | 604 | 425 | 638 |

All coating formulations A to E have a very high breaking strength of 3.6 to 5.09 N/mm² and at the same time high elongation at break of 425 to 856%. This performance is a confirmation of the good filler compatibility of the polyurethane dispersion according to the present invention compared to the prior art (Comparative Example 1).

All roof membrane formulations comprising the filler compatible polyurethane dispersions show a very high extensibility of more than 500% and breaking strengths of about 2 N/mm².

1-8. (canceled)

9. A binder, comprising:
an aqueous polyurethane dispersion comprising
a polyalkylene oxide content of at least 10 g/kg of polyurethane; and
a sulfonated raw material content of at least 25 mmol per kg of polyurethane.

10. The binder according to claim 9, wherein said aqueous polyurethane dispersion comprises a long-chain alkanol-based polyethylene oxide and a sodium salt of 2-aminoethyl-2-aminoethanesulfonic acid.

11. A filled coating material, comprising:
the binder according to claim 9.

12. A flexible roof coating, comprising:
the binder according to claim 9.

13. An architectural paint, comprising:
the binder according to claim 9.

14. A coating composition, comprising:
an aqueous polyurethane dispersion comprising
a polyalkylene oxide content of at least 10 g/kg of polyurethane; and
a sulfonated raw material content of at least 25 mmol per kg of polyurethane;
optionally at least one (in)organic filler and/or at least one (in)organic pigment;
optionally at least one customary assistant; and
water.

15. The coating composition according to claim 14, wherein said aqueous polyurethane dispersion comprises a long-chain alkanol-based polyethylene oxide and a sodium salt of 2-aminoethyl-2-aminoethanesulfonic acid.

16. A flexible roof coating, comprising:
the coating composition according to claim 14.

17. An architectural paint, comprising:
the coating composition according to claim 14.

18. A coated surface, of which at least a portion is covered with an aqueous polyurethane dispersion, said dispersion comprising
a polyalkylene oxide content of at least 10 g/kg of polyurethane; and
a sulfonated raw material content of at least 25 mmol per kg of polyurethane.

19. A building material substrate, comprising:
a main surface of which at least a portion is covered with an aqueous polyurethane dispersion comprising
a polyalkylene oxide content of at least 10 g/kg of polyurethane; and
a sulfonated raw material content of at least 25 mmol per kg of polyurethane.

20. An outer flexible roof coating composition, comprising:
an aqueous polyurethane dispersion comprising
a polyalkylene oxide content of at least 10 g/kg of polyurethane; and
a sulfonated raw material content of at least 25 mmol per kg of polyurethane.
